(19) United States
(12) Patent Application Publication
(10) Pub. No.: US 2010/0124714 A1
(43) Pub. Date: May 20, 2010

(54) DEVELOPING AGENT, IMAGE FORMING APPARATUS, AND IMAGE FORMING METHOD

(75) Inventor: Hiroshi Kawaguchi, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/619,730

(22) Filed: Nov. 17, 2009

Related U.S. Application Data
(60) Provisional application No. 61/115,152, filed on Nov. 17, 2008.

(51) Int. Cl. G03G 9/107; G03G 15/08; G03G 9/097; G03G 9/08; G03G 13/16

(52) U.S. Cl. 430/108.4; 399/252; 430/108.1; 430/111.41; 430/125.3

(57) ABSTRACT

A developing agent is used for a recycle type image forming apparatus including an image bearing body on which an electrostatic latent image is developed with the developing agent and an image transferred to a transfer medium is formed, and includes a toner particle, a magnetic carrier to charge the toner particle to a specified polarity, and a circulation agent which is charged to a polarity reverse to that of the toner particle in the developing agent, has a primary particle diameter of 20 to 100 μm, has a magnetization lower than that of the magnetic carrier, and has a transfer efficiency of 0 to 10% from the image bearing body to the transfer medium.

### CROSS-REFERENCE TO RELATED APPLICATION

This application is based upon and claims the benefit of priority from the prior U.S. Patent Application 61/115,152 filed on Nov. 17, 2008, the entire contents of which are incorporated herein by reference.

### TECHNICAL FIELD

The present invention relates to a developing agent used for a toner recycle type image forming apparatus, the image forming apparatus and an image forming method.

### BACKGROUND

In general, in an image forming apparatus using an electrophotographic system, toner is conveyed through a conveyance medium, for example, an electrostatic latent image bearing body such as a photoreceptor or an intermediate transfer medium such as a transfer belt, and is adhered to a desired position on a transfer medium such as a sheet. Then, a heat roller and the like apply heat and pressure, and the toner is fixed to the transfer medium, so that an image is formed on the transfer medium.

In the image forming apparatus as stated above, in general, the toner develops the electrostatic latent image on the photoreceptor, and is transferred to the transfer medium. A transfer remaining toner remaining on the photoreceptor or a fog toner which floats due to weak charging and is adsorbed onto the photoreceptor is removed by a cleaner such as a cleaning blade and is discarded. On the other hand, in recent years, in order to suppress the running cost, a recycle system is used in which toner after cleaning is collected and is recycled. By the recycle system, the transfer remaining toner or the fog toner (hereinafter referred to as the collected toner particle) collected by the cleaner from the photoreceptor is conveyed to a developing device through a conveyance path.

In the image forming apparatus including the toner recycle system as stated above, there is a problem that the collected toner particle whose fluidity is reduced by deterioration causes blocking in the conveyance path and causes defective conveyance. Such a problem is dealt with by an external addition treatment to toner or an improvement in conveyance mechanism.

For example, with respect to the external addition treatment, JP-A-2003-57881 discloses a method in which the amount of external additive is increased to improve the fluidity. Besides, with respect to the conveyance mechanism, JP-A-2004-177754 discloses a method in which a conveyance screw is provided in a conveyance path to improve the fluidity.

In recent years, energy saving is promoted, and it is necessary that a resin softening at a low temperature is used as the toner or a large amount of wax is added. Thus, there is a tendency that the fluidity of the collected toner is worsened by the influence thereof, and further improvement in the fluidity is required.

### SUMMARY

According to an aspect of the invention, a developing agent used in a recycle type image forming apparatus includes a toner particle, a magnetic carrier to charge the toner particle, and a circulation agent which is charged to a polarity reverse to that of the toner particle in the developing agent, has a primary particle diameter of 20 to 100 μm, has a magnetization lower than that of the magnetic carrier, and has a transfer efficiency of 0 to 10% from an image bearing body to a transfer medium.

According to another aspect of the invention, an image forming apparatus includes an image bearing body on which an electrostatic latent image is formed and an image transferred to a transfer medium is formed by supplying a developing agent to the electrostatic latent image to develop it, a developing device to supply the developing agent to the image bearing body, a cleaner to collect a constituent component of the developing agent remaining on the image bearing body from which the image is transferred to the transfer medium, and a conveyance path to convey the collected constituent component of the developing agent to the developing device, in which the developing agent includes a toner particle, a magnetic carrier to charge the toner particle, and a circulation agent which is charged to a polarity reverse to that of the toner particle in the developing agent, has a primary particle diameter of 20 to 100 μm, has a magnetization lower than that of the magnetic carrier, and has a transfer efficiency of 0 to 10% from the image bearing body to the transfer medium.

According to another aspect of the invention, an image forming method includes forming an electrostatic latent image on an image bearing body, forming an image on the image bearing body by supplying a developing agent from a developing device to the electrostatic latent image and by developing it, transferring the image to a transfer medium, collecting a constituent component of the developing agent remaining on the image bearing body, and conveying the collected constituent component of the developing agent to the developing device, in which the developing agent is used which includes a toner particle, a magnetic carrier to charge the toner particle, and a circulation agent which is charged to a polarity reverse to that of the toner particle in the developing agent, has a primary particle diameter of 20 to 100 μm, has a magnetization lower than that of the magnetic carrier, and has a transfer efficiency of 0 to 10% from the image bearing body to the transfer medium.

It is to be understood that both the forgoing general description and the following detailed description are exemplary and explanatory only and are not restrictive of the invention, as claimed.

### DESCRIPTION OF THE DRAWINGS

The accompanying drawings, which is incorporated in and constitute a part of this specification, illustrates an embodiment of the invention and together with the description, serve to explain the principles of the invention.

FIG. 1 is a side sectional view showing a structure of a two-component developing process image forming apparatus of an embodiment;

FIG. 2 is a side sectional view showing a structure of a four-drum tandem image forming apparatus of an embodiment; and

FIG. 3 is a table showing evaluation results of developing agents of examples of the embodiment and comparative examples.

### DETAILED DESCRIPTION

Reference will now be made in detail to the present embodiment of the invention, an example of which is illustrated in the accompanying drawing.

A developing agent of an embodiment is used in a recycle type image forming apparatus including an image bearing body on which an electrostatic latent image is developed with the developing agent, and an image transferred to a transfer medium is formed. The developing agent includes a toner particle, a magnetic carrier to charge the toner particle to a specified polarity, and a circulation agent which is charged to a polarity reverse to that of the toner particle in the developing agent, has a primary particle diameter of 20 to 100 μm, has a magnetization lower than that of the magnetic carrier, and has a transfer efficiency of 0 to 10% from the image bearing body to the transfer medium.

The toner particle of the embodiment is charged to the specified polarity, develops the electrostatic latent image on the image bearing body to form the image, and is transferred to the transfer medium. The toner particle includes a binder resin, a release agent, a coloring agent and the like.

As the binder resin, polyester resin, styrene-acrylic resin or the like can be used.

As the polyester resin, obtained by using a monomer containing a carboxylic acid component made of a divalent or higher-valent carboxylic acid compound and an alcohol component made of divalent or higher-valent alcohol is preferable.

As the acid component, for example, fumaric acid, maleic acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, or succinic acid substituted with alkyl group of carbon number of 1 to 20 or alkenyl group of carbon number of 2 to 20, such as dodecenyl succinic acid or octylsuccinic acid, acid anhydride of these, derivatives such as alkyl ester, and the like are enumerated.

As the alcohol component, for example, ethylene glycol, propylene glycol, 1,4-butanediol, 1,3-butanediol, 1,5-pentanediol, 1,6-hexanediol, neopentyl glycol, glycerine, trimethylol ethane, trimethylol propane, aliphatic polyol such as pentaerythritol, 1,4-cyclohexanediol, alicyclic polyol such as 1,4-cyclohexane dimethanol, ethylene oxide such as bisphenol A or propylene oxide adduct, and the like are enumerated.

As the styrene-acrylic resin, a polymer of styrenes, a copolymer of styrenes and dienes, a copolymer of styrenes and alkyl(meta)acrylate and the like are enumerated. Polyester resin and styrene-acrylic resin are used together.

As the release agent, natural wax such as carnauba wax, rice wax or candelilla wax, or synthetic wax such as polypropylene or polyethylene can be used.

As the coloring agent, carbon black, a yellow pigment such as P.Y180, P.Y74, P.Y17, P.Y185 or P.Y93, a magenta pigment such as P.R122, P.R185, P.R57:1, P.R31, P.R238, P.R269, P.R146, P.R147, P.R184 or P.V19, a cyan pigment such as P.B15 or P.G7 which are generally used for toner can be used.

Further, if necessary, a charging control agent for controlling friction charging charge amount (charging amount) may be mixed. As the charging control agent, for example, a metal-containing azo compound, a metal-containing salicylic acid derivative compound, or a metal oxide hydrophobed material is used. In this case, it is necessary to use the agent which imparts a polarity different from the after-mentioned circulation agent. One or more kinds of such charging control agents can be used.

The binder resin, the release agent, the coloring agent, and the like are melted and mixed, and the obtained mixture is dried, pulverized and classified, so that a core toner can be obtained.

It is preferable that the volume average particle diameter of the core toner is 3 to 7 μm. When the volume average particle diameter is smaller than 3 μm, when a charge amount capable of controlling by electric field is given to each toner particle, a charging amount per weight becomes excessively large, and it becomes difficult to obtain a desired developing amount. Besides, when the volume average particle diameter is larger than 7 μm, the reproducibility or granularity of a fine image is deteriorated. The volume average particle diameter is more preferably 4 to 6 μm.

Although the obtained core toner can be used as the toner particle as it is, in general, an external additive particle or the like is added to the surface of the core toner and it is used:

The external additive particle to stabilize the fluidity, charging property, and storage property can be added to the surface of the core toner. For example, an oxide containing metal such as Ti, Si, Al, St, Fe, Mn, Mg, Zn or Cu can be used. Besides, an external additive particle functioning as a lubricant of a drum cleaner can be added. For example, higher fatty acid (metal soap) containing Zn, Ca, Mg, Al or the like, or a resin containing fluorine can be used.

With respect to the toner particle constituted as stated above, as stated below, an initial developing agent is first supplied to the developing device of the image forming apparatus, is developed on the image bearing body, and is consumed. In accordance with the amount of consumption of the toner particle, a new toner particle is supplied to the developing device. At this time, the composition of the toner particle in the initial developing agent may be different from that of the supplied toner particle.

The magnetic carrier in this embodiment is used for charging the toner particle to a specified polarity. That is, in the after-mentioned toner recycle type image forming apparatus, the magnetic carrier is retained by magnetic force of a developing agent support, stays in the developing device without being developed onto the image bearing body, and can cause the toner particle to have a desired charging amount by friction against the toner particle.

The magnetic carrier includes a magnetic particle of ferrite, magnetite, iron oxide or the like, a resin particle mixed with a magnetic powder of these, a particle in which at least part of a surface of the magnetic powder or the like is coated with resin such as fluorine resin, silicone resin, or acrylic resin, or the like.

It is preferable that the primary particle diameter (D50) of the magnetic carrier particle is 20 to 100 μm. When the primary particle diameter is smaller than 20 μm, since the magnetic force of one particle is small, the particle is separated from the developing agent support and becomes liable to adhere to the photoreceptor. When it is larger than 100 μm, a magnetic brush becomes hard, and brush marks of the magnetic brush appear on an image, or fine toner supply becomes impossible. The primary particle diameter is more preferably 30 to 60 μm.

In the after-mentioned toner recycle type image forming apparatus, the circulation agent of the embodiment is mixed in the initial developing agent, or is, together with the supply toner, supplied to the developing device suitably. Then, the circulation agent is developed onto the image bearing body, and is, together with the transfer remaining toner or fog toner, collected by the cleaner, and then, the circulation agent is conveyed to the developing device through a recycle toner conveyance path. As stated above, the circulation agent is used for improving the fluidity of the developing agent including the collected toner particle by circulation through the image bearing body, the cleaner, and the recycle toner conveyance path.

It is necessary that the circulation agent is charged to the polarity reverse to that of the toner particle in the developing agent. When the circulation agent is charged to the polarity reverse to that of the toner particle, the collected toner particle is electrostatically captured and can be conveyed.

Further, in order to improve the fluidity of the developing agent, it is necessary that the circulation agent has a primary particle diameter of 20 to 100 μm. When the primary particle diameter is smaller than 20 μm, the improvement of the fluidity is suppressed, and in the after-mentioned toner recycle type image forming apparatus, blocking occurs in the recycle toner conveyance path. When the primary particle diameter is larger than 100 μm, a white spot phenomenon occurs on the transfer medium, such as a sheet, at the time of transfer. The primary particle diameter is more preferably 30 to 60 μm.

Further, it is necessary that the circulation agent has a magnetization lower than that of the magnetic carrier. When the magnetization of the circulation agent is equal to or larger than the magnetization of the magnetic carrier, in the after-mentioned toner recycle type image forming apparatus, since the circulation agent is continued to be kept on the development roller for supplying the developing agent onto the image bearing body, the circulation agent does not flow into the recycle toner conveyance path, and clogging occurs in the recycle toner conveyance path.

Further, it is necessary that the circulation agent has a transfer efficiency of 0 to 10% from the image bearing body to the transfer medium. Although it is ideal that the transfer efficiency is 0, it may be 10% or less. When it exceeds 10%, in the after-mentioned toner recycle type image forming apparatus, since the circulation agent is transferred from the image bearing body to the transfer medium, it is consumed. Accordingly, the amount (content ratio) of the circulation agent passing through the recycle toner conveyance path is decreased, and clogging occurs in the recycle toner conveyance path.

Here, as the image bearing body, a well-known photoreceptor, such as a plus charging or minus charging OPC (Organic Photoconductor) or amorphous silicon, is used. As the transfer medium, a final transfer medium such as a paper, an intermediate transfer medium such as a transfer roller and a transfer belt are enumerated. The transfer efficiency is represented by

[(amount of circulation agent transferred onto the transfer medium/amount of circulation agent remaining on the image bearing body)×100(%)].

At this time, an amount determining method of the circulation agent is suitably selected according to the constituent component of the circulation agent.

Further, it is necessary that the blending quantity of the circulation agent is 1 to 30% by mass in the initial developing agent. Besides, it is preferable that the circulation agent is similarly contained in the developing agent which includes the toner particle collected by the cleaner, passes through the recycle toner conveyance path, and is conveyed to the developing device. In the after-mentioned toner recycle type image forming apparatus, when the content is less than 1% by mass, the amount (content ratio) of the circulation agent passing through the recycle toner conveyance path is decreased. When the content exceeds 30% by mass, the amount (content ratio) of the toner particle and the magnetic carrier in the developing device is decreased, and the amount of the toner particle becomes insufficient, and accordingly, a blade trace of a developing device mixer appears.

As the circulation agent, for example, non-magnetic macromolecules containing acryl resin, styrene acryl resin, polyester resin, polystyrene, polyethylene, polyethylene terephthalate, phenol resin, urea resin, urethane foam, polycarbonate, EVA resin, ABS resin, methacryl resin, polyamide, silicone resin, epoxy resin, polyvinyl alcohol, polyacetal, alkyd resin, AS resin, melamine resin, polyphenylene ether, polyvinylidene chloride, polybutylene, polybutylene terephthalate, polybutene, epoxy resin, urethane resin, fluorine resin, polymethylpentene, polybutadiene, styrene-butadiene resin, poly vinyl acetate, ionomer, AAS resin, ACS resin, polymethyl methacrylate, polytetrafluoroethylene, ethylene polytetrafluoroethylene copolymer, polyarylate, polyethersulfone, polyimide, polyamide-imide, polyphenylene sulfide, polyoxy benzoyl, polyetheretherketone, polyetherimide, polyolefin, acetylcellulose, cellulose butyrate, cellophane, celluloid, isoprene, acrylonitrile or the like are enumerated. Besides, mixtures of the macromolecules and a magnetic material, such as inorganic oxide or ferrite, a charging control agent or the like are enumerated. Besides, metal soap containing zinc, calcium, magnesium, aluminum or the like, inorganic oxide containing silicon, titanium, aluminum, strontium, magnesium or the like, a material which includes the inorganic oxide as a core agent and the surface of which is treated by silane coupling agent or silicone oil when required, and the like are enumerated.

By using the developing agent as stated above, an image is formed by, for example, an electrophotographic process using an image forming apparatus as described below.

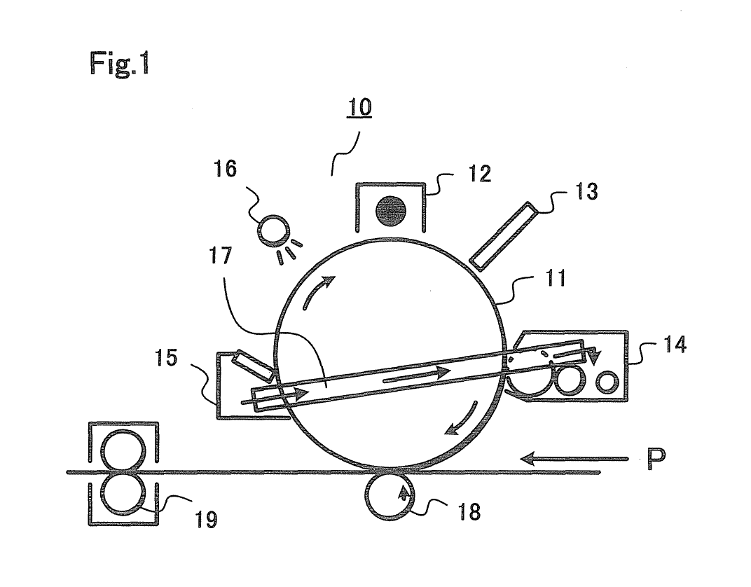

FIG. 1 shows a toner recycle type image forming apparatus. The image forming apparatus 10 includes a photoreceptor 11 as an image bearing body, a charging device 12 to charge a photoreceptor 11, an exposure device to form an electrostatic latent image on the photoreceptor 11, a developing device 14 including a development roller to supply a developing agent onto the photoreceptor 11 to perform development, a photoreceptor cleaner 15 to remove and collect a transfer remaining toner or the like, a charge-removal device 16 to remove an electrostatic latent image after development and transfer, a recycle toner conveyance path 17 to convey the collected toner from the photoreceptor cleaner 15 to the developing device 14, a transfer device 18 to transfer an image on the photoreceptor 11 to a transfer medium P, a fixing device 19 to fix the image to the transfer medium P, and the like.

An image is formed on the transfer medium P by using the image forming apparatus as stated above and in a process as described below.

First, the photoreceptor 11 is uniformly charged to a desired potential by the charging device 12 such as a charge wire, a comb charger, a corona charger such as a scorotron, a contact charging roller, a non-contact charging roller, a solid charger, or a contact charging brush, which are known. Further, the exposure device 13 using a known unit, such as a laser or an LED, performs exposure, so that an electrostatic latent image is formed on the photoreceptor 11 in accordance with image information.

The developing agent supplied to the developing device 14 is conveyed to the development roller containing a mag roller, and the charged toner particle is supplied and adhered to the electrostatic latent image on the photoreceptor 11 by a magnetic brush phenomenon, so that development is performed and an image is formed. At this time, not only the toner particle, but also the circulation agent is developed. In order to form such an electric field that the toner particle is uniformly and stably adhered, a development bias of DC or DC superimposed with AC is applied to the development roller.

The toner particle and the circulation agent not developed are separated from the development roller at a peeling pole position of the mag roller, and are collected in the developing device. For example, a well-known toner density sensor is attached to the developing device, and when the density sensor detects that the toner density is decreased, a new toner particle is supplied. At this time, the circulation agent is also newly supplied. Incidentally, toner consumption is estimated by detecting one of or both of the accumulation of print data and the amount of development toner on the photoreceptor and the new toner particle may be supplied based on that. Besides, both the sensor output and the estimation of the consumption may be used.

The formed image is applied with a transfer voltage by the transfer device 18 arranged to be in contact with the photoreceptor 11, and is transferred to the transfer medium P such as a sheet. The transfer medium P to which the image is transferred is peeled from the photoreceptor 11, is conveyed to the fixing device 19, and is fixed by a known heating and press fixing unit such as a heat roller.

After the image is transferred, toner particles such as the transfer remaining toner and fog toner, which are not transferred but remain on the photoreceptor 11, and the circulation agent, which has such a property that transfer to the transfer medium is hard to perform and remains on the photoreceptor 11, are removed and collected by the photoreceptor cleaner 15. The electrostatic latent image on the photoreceptor 11 is erased by the charge-removal device 16. The toner particles and the circulation agent removed and collected by the photoreceptor cleaner 15 are collected in the developing device 14 through the recycle toner conveyance path 17 by an agitating auger or the like and are again used.

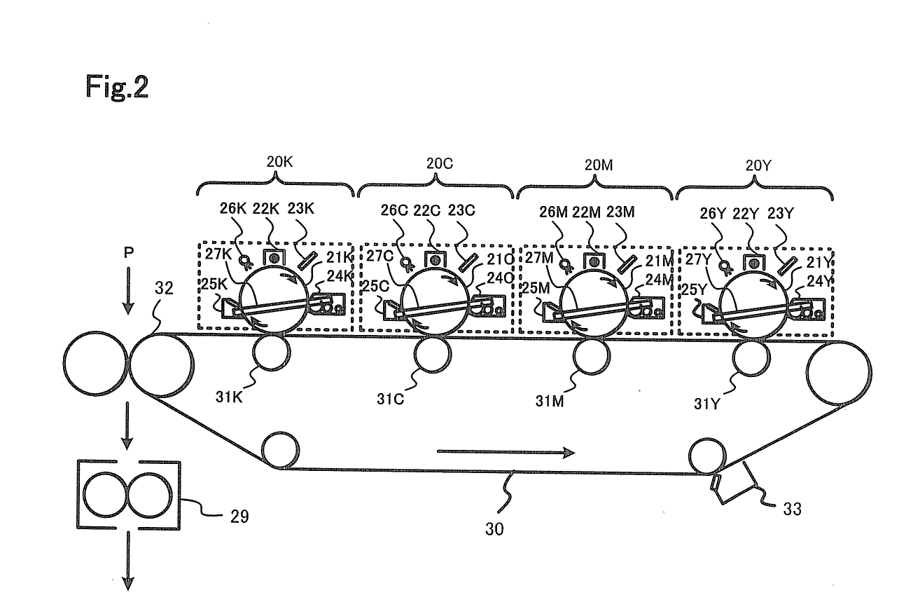

FIG. 2 is a schematic view of a toner recycle type 4-drum tandem image forming apparatus. As shown in FIG. 2, image formation units 20Y, 20M, 20C and 20K including respective color toner particles of yellow, magenta, cyan and black are provided for the four colors, and are arranged in parallel along a conveyance path of an intermediate transfer belt 30.

The intermediate transfer belt 30 travels endlessly at a constant speed in an arrow direction, and the respective image formation units 20Y, 20M, 20C and 20K are disposed in series along the conveyance direction of the intermediate transfer belt 30 so that axial lines of photoreceptors 21Y, 21M, 21C and 21K are spaced from each other at equal intervals. Incidentally, the respective structures of the image formation units 20Y, 20M, 20C and 20K are equal to each other. Accordingly, the image formation unit 20Y is used as an example, and its structure is described.

The image formation unit 20Y includes a photoreceptor 21Y as an image bearing body, a charging device 22Y to charge the photoreceptor 21Y, an exposure device 23Y to form an electrostatic latent image, a developing device 24Y to supply a toner particle to the electrostatic latent image, a primary transfer roller 31Y to transfer an image formed on the photoreceptor, a photoreceptor cleaning device 25Y to remove and collect a transfer remaining toner, and a charge-removal device 26Y to remove the electrostatic latent image, and they are arranged along the rotation direction of the photoreceptor 21Y. Further, a recycle toner conveyance path 27Y to convey the collected toner from the photoreceptor cleaning device 25Y to the developing device 24Y is provided.

A not-shown drum motor to rotate the photoreceptor 21Y at a specified peripheral speed is connected to the photoreceptor 21Y. The axial line of the photoreceptor 21Y is disposed to be orthogonal to the direction in which the image is conveyed by the intermediate transfer belt 30.

The primary transfer roller 31Y is disposed at a position where the intermediate transfer belt 30 is nipped between the primary transfer roller and the photoreceptor 21Y, that is, at the inside of the intermediate transfer belt 30. Further, the intermediate transfer belt 30 is in contact with a secondary transfer roller 32.

Incidentally, here, although the example is described in which the image formation units are arranged in color order of yellow (Y), magenta (M), cyan (C) and black (K), the color order is not particularly limited.

The image forming apparatus as described above is used and an image is formed in a manner as described below.

First, the charging unit 22Y uniformly and negatively (−) charges the photoreceptor 21Y. The charged photoreceptor 21Y is exposed by the exposure device 23Y in accordance with image information, so that an electrostatic latent image is formed. The electrostatic latent image on the photoreceptor 21Y is reversely developed by the developing device 24Y, and a toner image is formed on the photoreceptor 21Y.

A bias (+) reverse to the charging polarity of the toner is applied to the primary transfer roller 31Y by a not-shown power source. As a result, the toner image on the photoreceptor 21Y is primarily transferred onto the transfer belt 30 by a transfer electric field formed between the photoreceptor 21Y and the primary transfer roller 31Y. The photoreceptor 21Y after transfer is cleaned by the photoreceptor cleaner 25Y, the electrostatic latent image is removed by the charge-removal device 26Y, and the process of charging, exposure and development is again repeated. The toner removed and collected by the photoreceptor cleaner 25Y is collected in a developing agent storage unit of the developing device 24Y through the recycle toner conveyance path 27Y.

The same process is performed also in the image formation units 20M, 20C and 20K in timing with the formation of the toner image by the image formation unit 20Y, and toner images of magenta, cyan and black formed on the photoreceptors of the image formation units 20M, 20C and 20K are also primarily transferred onto the intermediate transfer belt 30 in sequence.

The transfer medium P is conveyed from a cassette (not shown), and is sent to the intermediate transfer belt 30 by a not-shown aligning roller in timing with the toner image on the intermediate transfer belt 30.

A bias (+) reverse to the charge polarity of the toner is applied to the secondary transfer roller 32 by a power source (not shown). As a result, the toner image on the intermediate transfer belt 30 is transferred to the transfer medium P passing through between the intermediate transfer belt 30 and the secondary transfer roller 32 by transfer electric field formed between them. A fixing unit 29 for fixing the toner transferred onto the transfer medium P is disposed, and the fixed image is obtained by causing the transfer medium P to pass through the fixing unit 29. At this time, part of the toner not completely transferred to the transfer medium P and remaining on the transfer belt is removed by a cleaner 33.

Hereinafter, the embodiment will be described more specifically.

### [Preparation of Toner Particle]

Materials disclosed below are mixed at the following mixing ratio by using a Henschel mixer, and are kneaded by an extruder-type melt kneading apparatus, and then, they are pulverized and classified to have a specified particle diameter, and a core toner is obtained. External additives are added to the core toner at the following mixture ratio, and are mixed for a specified time by the Henschel mixer, and a toner particle is obtained.

(Core toner)

| polyester resin (binder resin) | 89.5 | wt % |
|---|---|---|
| carbon black (coloring agent) | 5 | wt % |
| carnauba wax (release agent) | 4 | wt % |
| charging control agent | 1.5 | wt % |
| (External additive) (to the core toner 100 wt %) | | |
| titanium oxide | specified amount | |
| silica | 1 | wt % |
| metal soap (cleaner lubricant) | 0.1 | wt % |

### [Preparation of Circulation Agent]

Materials disclosed below are mixed at the following mixture ratio by using the Henschel mixer, and are kneaded by the extruder-type melt kneading apparatus, and then, they are pulverized and classified to have specified particle diameters, and circulation agents of examples 1 to 6 and comparative examples 1 to 8 are obtained.

Incidentally, the transfer efficiency is influenced by the charging polarity of the circulation agent and the size, and can be suitably controlled by the amount of charging control agent or the like. Besides, the magnetization can be controlled by the amount and kind of magnetic material contained in the circulation agent.

Circulation Agent 1 (Examples 1, 3 to 6, Comparative Examples 2 to 5)

| | |
|---|---|
| polyester resin | 89% |
| carnauba wax | 5% |
| COPY bule PR (made by Hoechst AG; charging control | 2% |
| agent for positive charging) | |
| carbon black | 4% |
| Circulation agent 2 (example 2) | |
| polyester resin | 90.5% |
| carnauba wax (release agent) | 5% |
| COPY bule PR (made by Hoechst AG; charging control | 0.5% |
| agent for positive charging) | |
| carbon black (coloring agent) | 4% |
| Circulation agent 3 (comparative example 1) | |
| polyester resin | 90.9% |
| carnauba wax (release agent) | 5% |
| COPY bule PR (made by Hoechst AG; charging control | 0.1% |
| agent for positive charging) | |
| carbon black (coloring agent) | 4% |
| Circulation agent 4 (comparative example 6) | |
| polyester resin | 1% |
| COPY bule PR (made by Hoechst AG; charging control | 0.5% |
| agent for positive charging) | |
| magnetic powder | 98.5% |
| Circulation agent 5 (comparative example 7) | |
| polyester resin | 5% |
| COPY bule PR (made by Hoechst AG; charging control | 0.5% |
| agent for positive charging) | |
| magnetic powder | 94.5% |
| Circulation agent 6 (comparative example 8) | |
| polyester resin | 89% |
| carnauba wax (release agent) | 5% |
| COPY bule PR (charging control agent for negative | 2% |
| charging) | |
| carbon black (coloring agent) | 4% |

The characteristics of the obtained circulation agent are measured in a manner as described below.

### (Transfer Efficiency of the Circulation Agent)

A mesh having an opening corresponding to the particle diameter of the circulation agent added to the toner is prepared, un-used toner (toner before it is supplied to the developing device: A) and toner remaining on the photoreceptor after passing through the nip between the photoreceptor and the transfer medium (transfer remaining toner: B) are sifted, and calculation is performed based on the weight ratio thereof. A calculation expression is as follows.

transfer efficiency=B/A×100(%)

### (Particle Diameter)

The particle diameter of the circulation agent is measured by using a micro truck (9320HRA X100 made by Honeywell)

### (Magnetization)

A VSM (vibrating sample magnetometer; VSM-P7-15 made by TOEI INDUSTRY CO., LTD.) is used, the weight of a sample is measured, it is packed in a capsule and is measured, and the magnetization per unit weight is obtained from the result, and is compared with the magnetization of the carrier used.

Magnetic carriers are mixed in the obtained toner particles and circulation agents, and the developing agents of the examples and the comparative examples are obtained.

The developing agents are used and the following evaluation is performed. Incidentally, an apparatus used is a composite machine e-STUDIO280 made by Toshiba, a test environment is such that temperature is 20 to 25° C., and humidity is 40 to 60%, a chart has a print ratio of 8%, and data is acquired after 100,000 sheets are used.

### (Clogging of the Recycle Toner Conveyance Path)

After 100,000 sheets are used, an example in which a machine stop or a defective image due to clogging of the recycle conveyance path does not occur is denoted by ◯, and an example in which it occurs is denoted by x.

### (Image of Blade Trace of the Developing Device Mixer)

After 100,000 sheets are used, an example in which the blade trace of the developing device mixer does not appear on the solidly shaded image of A3 size is denoted by ◯, and an example in which it appears is denoted by x.

### (White Spot Image)

After 100,000 sheets are used, the number of white spots occurring on the solidly shaded image of A3 size due to the circulation agent as a cause (core) is confirmed.

The determination criterion is as follows.

◯: There is no occurrence of 10 pieces/A3 or more.

x: There is at least one occurrence of 10 pieces/A3 or more.

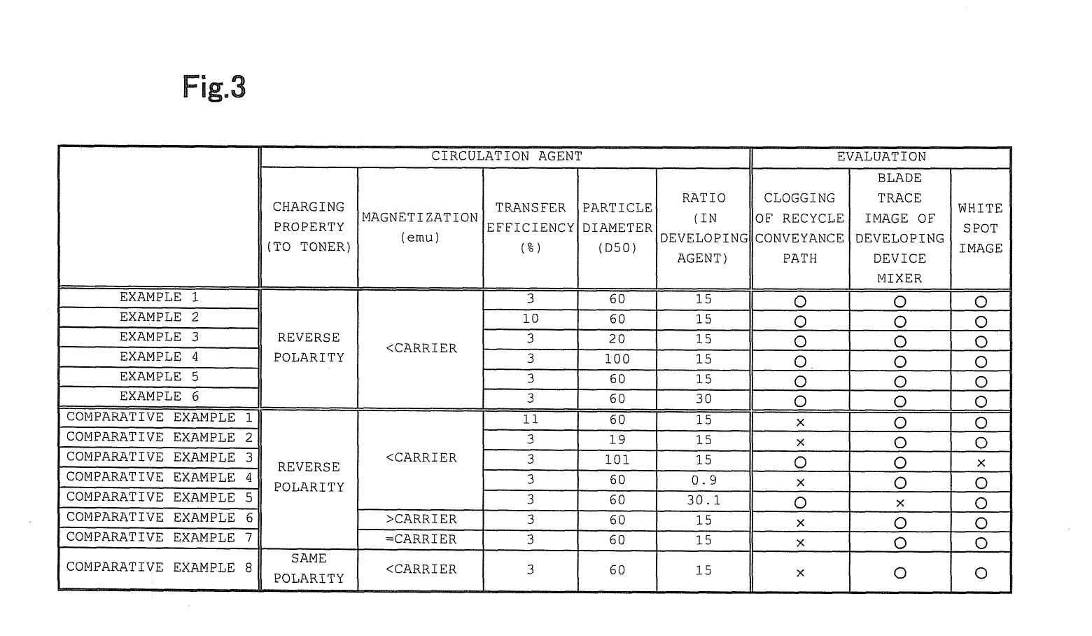

FIG. 3 shows evaluation results of the respective examples and comparative examples. As shown in FIG. 3, it is understood that in examples 1 to 6, there is no problem and sufficient effects can be obtained.

In comparative example 1, since the transfer efficiency of the circulation agent is larger than the specified range, the amount of the circulation agent passing through the recycle toner conveyance path becomes insufficient, and clogging of the recycle toner conveyance path occurs.

In comparative example 2, since the particle diameter of the circulation agent is smaller than the specified range, the fluidity of the toner in the recycle toner conveyance path is not improved, and clogging of the recycle toner conveyance path occurs.

In comparative example 3, since the particle diameter of the circulation agent is larger than the specified range, white spots occur on the solidly shaded area.

In comparative example 4, since the ratio of the circulation agent in the developing agent is smaller than the specified range, the amount of the circulation agent passing through the recycle toner conveyance path becomes insufficient, and clogging of the recycle toner conveyance path occurs.

In comparative example 5, since the ratio of the circulation agent in the developing agent is larger than the specified range, the amount of the carrier and the toner in the developing device becomes insufficient, and a blade trace occurs.

In comparative example 6, since the magnetization of the circulation agent is larger than the magnetization of the carrier used, the circulation agent is continued to be kept on the development roller, the circulation agent does not flow into the recycle toner conveyance path, and clogging of the recycle toner conveyance path occurs.

In comparative example 7, since the magnetization of the circulation agent is equal to the magnetization of the carrier used, the circulation agent is continued to be kept on the development roller, the circulation agent does not flow into the recycle toner conveyance path, and clogging of the recycle toner path occurs.

In comparative example 8, since the circulation agent is charged to the same polarity as that of the toner in the developing agent, the toner in the recycle toner conveyance path can not be electrostatically captured and conveyed, and clogging of the recycle toner conveyance path occurs.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developing agent used for a recycle type image forming apparatus including an image bearing body on which an electrostatic latent image is developed with the developing agent and an image transferred to a transfer medium is formed, comprising:
a toner particle;
a magnetic carrier to charge the toner particle to a specified polarity; and
a circulation agent charged to a polarity reverse to a polarity of the toner particle in the developing agent, the circulation agent having a primary particle diameter of 20 to 100 μm, the circulation agent having a magnetization lower than a magnetization of the magnetic carrier, the circulation agent having a transfer efficiency of 0 to 10% from the image bearing body to the transfer medium, and the circulation agent having a content of 1 to 30 wt % in the developing agent.

2. The developing agent of claim 1, wherein the circulation agent is non-magnetic.

3. The developing agent of claim 1, wherein the primary particle diameter of the circulation agent is 30 to 60 μm.

4. The developing agent of claim 1, wherein the circulation agent includes a macromolecule.

5. The developing agent of claim 4, wherein the macromolecule includes a polyester resin.

6. The developing agent of claim 4, wherein the circulation agent further includes one of a magnetic particle and a charging control agent.

7. The developing agent of claim 1, wherein the circulation agent includes one of a metal soap and an inorganic oxide.

8. The developing agent of claim 7, wherein the circulation agent includes a core of one of the metal soap and the inorganic oxide, and a surface coating layer to cover a surface of the core.

9. The developing agent of claim 1, wherein the transfer medium is a paper.

10. An image forming apparatus of recycle type for forming an image on a transfer medium, comprising:
an image bearing body configured to form an electrostatic latent image on the image bearing body, and the image bearing body configured to form an image transferred to the transfer medium by developing the electrostatic latent image by supplying a developing agent on the image bearing body;
a developing device configured to supply the developing agent to the image bearing body;
a cleaner configured to collect a constituent component of the developing agent remaining on the image bearing body from which the image is transferred to the transfer medium; and
a conveyance path configured to convey the collected constituent component of the developing agent to the developing device,
wherein the developing agent includes a toner particle, a magnetic carrier to charge the toner particle to a specified polarity, and a circulation agent charged to a polarity reverse to a polarity of the toner particle in the developing agent, the circulation agent having a primary particle diameter of 20 to 100 μm, the circulation agent having a magnetization lower than a magnetization of the magnetic carrier, the circulation agent having a transfer efficiency of 0 to 10% from the image bearing body to the transfer medium, and the circulation agent having a content of 1 to 30 wt % in the developing agent.

11. The apparatus of claim 10, wherein the circulation agent is non-magnetic.

12. The apparatus of claim 10, wherein the primary particle diameter of the circulation agent is 30 to 60 μm.

13. The apparatus of claim 10, wherein the circulation agent includes a macromolecule.

14. The apparatus of claim 10, wherein the circulation agent includes one of a metal soap and an inorganic oxide.

15. The apparatus of claim 10, wherein the transfer medium is a paper.

16. An image forming method of recycle type for forming an image on a transfer medium, comprising:
forming an electrostatic latent image on an image bearing body;
forming an image on the image bearing body by developing the electrostatic latent image with a developing agent supplied from a developing device;
transferring the image to a transfer medium;
collecting a constituent component of the developing agent remaining on the image bearing body; and
conveying the collected constituent component of the developing agent to the developing device,
wherein the developing agent includes a toner particle, a magnetic carrier to charge the toner particle to a specified polarity, and a circulation agent charged to a polarity reverse to a polarity of the toner particle in the developing agent, the circulation agent having a primary particle diameter of 20 to 100 μm, the circulation agent having a magnetization lower than a magnetization of the magnetic carrier, the circulation agent having a transfer efficiency of 0 to 10% from the image bearing body to the transfer medium, and the circulation agent having a content of 1 to 30 wt % in the developing agent.

17. The method of claim 16, wherein the circulation agent is non-magnetic.

18. The method of claim 16, wherein the primary particle diameter of the circulation agent is 30 to 60 μm.

19. The method of claim 16, wherein the circulation agent includes at least one of a macromolecule, a metal soap and an inorganic oxide.

20. The method of claim 16, wherein the transfer medium is a paper.
